(19) United States
(12) Patent Application Publication
(10) Pub. No.: US 2026/0316026 A1
(43) Pub. Date: Oct. 15, 2026

(54) STIRRING DEVICES, CANISTERS AND MILK TEA MACHINES

(71) Applicant: Dongguan ZEEWAY-Technology Ltd, Dongguan City (CN)

(72) Inventors: Mengyi Zhu, Dongguan City (CN); Liang Zhou, Dongguan City (CN); Jinjun Lv, Dongguan City (CN); Shengguang Chen, Dongguan City (CN)

(73) Assignee: Dongguan ZEEWAY-Technology Ltd, Dongguan City (CN)

(21) Appl. No.: 19/322,986

(22) Filed: Sep. 9, 2025

(30) Foreign Application Priority Data
Apr. 15, 2025 (CN) 2025207025200
Jun. 18, 2025 (CN) 2025212548881

(51) Int. Cl. B01F 35/32; B01F 27/113; B01F 101/14

(52) U.S. Cl. CPC B01F 35/3204; B01F 27/113; B01F 2101/14

(57) ABSTRACT

A stirring device is provided, which includes a motor, a driving magnet operatively connected to the motor, and a canister. The canister includes a stirring container and a stirring impeller rotatably provided at the bottom of the stirring container. A magnet in the stirring impeller is arranged correspondingly to the driving magnet. One of the driving magnet and the magnet in the stirring impeller includes an integrated magnetic ring, which includes one or more sets of N and S magnetic poles arranged in the circumferential direction, and the other of the two magnets includes a corresponding magnet that cooperates with the magnetic ring and can rotate the stirring impeller through magnetic force. A canister and a milk tea machine are provided as well.

### TECHNICAL FIELD

This application relates to the field of preparation of beverages and, more specifically to stirring devices, canisters and milk tea Machines.

### BACKGROUND

During milk tea making nowadays, a variety of mixed materials are usually required. In particular, the materials are often in form of solid-liquid mixture. Therefore, during the milk tea preparation process, some materials in the canisters may settle, leading to a separation of the materials into upper and lower layers, for example, the lower layer consists of solid sediment, while the upper layer contains liquid materials. This separation of the upper and lower layers of the materials will lead to a poor taste, so it is necessary to mix them well before preparation of the drink. Magnetic stirring devices are more favoured in the industry of milk tea making. However, existing magnetic stirring devices are usually complex in structure, and in order to provide a sufficient stirring force, size of the magnet is also large, not suitable for small-sized canisters.

### SUMMARY

A purpose of present application is to solve or at least partially alleviate the above-mentioned problems by providing a stirring device and a canister with a magnetic driven stirring impeller, as well as a milk tea machine with the same canister.

In a first aspect, the present application provides a stirring device. The stirring device includes a motor, a driving magnet operatively connected to the motor, and a canister. The canister includes a stirring container and a stirring impeller that is rotatably provided at the bottom of the stirring container. The magnets in the stirring impeller are disposed correspondingly to the driving magnets. One of the driving magnet and the magnet in the stirring impeller includes an integrated magnetic ring, which includes one or more sets of N and S magnetic poles provided in the circumferential direction, and the other of the two magnets includes a corresponding magnet that cooperates with the magnetic ring and can rotate the stirring impeller through magnetic force.

Preferably, the outer contour size of the driving magnet is greater than that of the magnet in the stirring impeller, or the thickness of the driving magnet is greater than that of the magnet in the stirring impeller.

Preferably, the stirring impeller is detachably connected to a support shaft fixed at the bottom of the stirring container.

Preferably, the outer surface of the magnet in the stirring impeller is coated with a food grade material layer, with spaced convex blades formed on the material layer, and/or frame-shaped blades formed on the material layer.

Preferably, the outer surface of the magnet in the stirring impeller is coated with a layer of ferritic stainless steel or martensitic stainless steel.

Preferably, the motor and driving magnet are sealed within the base housing, and the base housing and stirring container are separately arranged.

Preferably, one or more installation regions for the stirring container are provided on the upper surface of the base housing, so that the stirring impeller inside the stirring container is disposed correspondingly to the driving magnet.

Preferably, the drive magnet and the stirring impeller each comprise a magnetic ring of the same structure. The magnetic ring of the same structure comprises n groups of N, S magnetic poles, wherein n is greater than or equal to 1.

Preferably, n is 2 and the n sets of N, S magnetic poles are spaced apart.

In a second aspect, the present application provides a canister for use in the stirring device as described above.

In a third aspect, the present application provides a milk tea machine comprising the canister as described above. The canister is in communication with an material conveying system of the milk tea machine.

### BRIEF DESCRIPTION OF DRAWINGS

The other features, objectives, and advantages of the present application will become more apparent by reading detailed description of non-limiting embodiments with reference to following figures:

FIG. 1 illustrates symbolically a stirring device according to an embodiment of the present application, in which the base housing and multiple canisters placed on it are shown.

FIG. 2 is the front view of FIG. 1.

FIG. 3 illustrates a schematic cross-sectional view taken along line A-A in FIG. 2.

FIG. 4 is a cross-sectional view of the canister in FIG. 3.

FIG. 5 is a cross-sectional view of the base housing in FIG. 3.

FIG. 6 is a schematic diagram of the magnet structure of the stirring impeller in the present embodiment of the stirring device.

FIG. 7 is a schematic diagram of an alternative magnet structure for the stirring impeller.

FIG. 8 illustrates a schematic partial front view of the driving magnet and stirring impeller in the assembly position in this embodiment of the stirring device.

FIG. 9 is a cross-sectional view taken along F-F in FIG. 8.

FIG. 10 shows a schematic partial front view of an alternative drive magnet and stirring impeller in assembly position.

FIG. 11 shows a cross-sectional view taken along the line E-E in FIG. 10.

FIG. 12 shows a perspective view of the stirring impeller in this embodiment of the stirring device.

FIG. 13 is a front view of the stirring impeller in FIG. 12.

FIG. 14 shows the cross-sectional view taken along D-D in FIG. 13.

FIGS. 15 and 16 show the front views of alternative stirring impellers.

FIG. 17 illustrates a stirring device according to another embodiment of the present application, in which only one canister placed on the base housing is shown.

FIG. 18 shows the front view of FIG. 17.

FIG. 19 illustrates schematically the cross-sectional view taken along line B-B in FIG. 18.

FIG. 20 shows a schematic perspective view of the stirring impeller in FIG. 19.

FIG. 21 shows the front view of FIG. 20.

FIG. 22 shows a cross-sectional view taken along line C-C in FIG. 21.

FIG. 23 shows a top view of FIG. 21.

Reference numbers: 11, 21 canister; 12, 22 base housing; 13, 13′, 13″, 23 stirring impeller; 14, 14′, 24 driving magnet; 15, 15′, 15″, 25 blade; 16, 16′, 26 magnet ring; 17, 27 support shaft; 18, 28 material layer; 19, 29 motor; 110 first snap part; 111 second snap part; 212 installation region.

### DETAILED DESCRIPTION

Below, a further detailed explanation of the present application will be provided in conjunction with the accompanying drawings and embodiments. It can be understood that the specific embodiments as described here are only used to explain the relevant application, and not to limit the application. Additionally, it should be noted that for ease of description, only the parts related to the application are shown in the accompanying drawings. Moreover, in order to clearly describe the present application, some of its components have been exaggerated. These do not constitute any limitation on the scope of protection scope of the present application.

It should also be noted that the directional words such as upper and lower mentioned herein are relative to the accompanying drawings, only for the convenience of description and understanding, and do not constitute any limitation on the scope of protection of the present application.

The stirring device of this application mainly includes a motor, a driving magnet, and a canister. The driving magnet is operatively connected to the motor. The canister includes a stirring container and a stirring impeller. The stirring impeller is rotatably provided at the bottom of the stirring container. The magnet in the stirring impeller is disposed correspondingly to the driving magnet. Usually, the stirring impeller is correspondingly disposed above the driving magnet. One of the driving magnet and the magnet in the stirring impeller may include an integrated magnetic ring. The magnetic ring may include more than one sets of N and S magnetic poles disposed in the circumferential direction. That is to say, the magnetic ring is composed of more than one sets of N and S magnetic pole regions. The other of the driving magnet and the magnet in the stirring impeller may include a corresponding magnet that cooperates with the magnetic ring and can drive the stirring impeller to rotate through magnetic force.

For example, the magnet in the stirring impeller may be a magnetic ring with more than one set of N and S magnetic pole regions, and the driving magnet is two traditional magnets with N and S magnetic poles facing magnetic poles of the stirring impeller and arranged in a carrying pole structure; Alternatively, the driving magnet can be a magnetic ring with more than one set of N and S magnetic pole regions, while the magnet in the stirring impeller can be two traditional magnets with N and S magnetic poles facing magnetic poles of the driving magnet and arranged in a carrying pole structure; Or, alternatively, the magnet in the stirring impeller can be a magnetic ring with more than one set of N and S magnetic pole regions, and the driving magnet can also be a magnetic ring with more than one set of N and S magnetic pole regions. The N and S magnetic poles of the magnetic ring of the stirring impeller correspond to the S and N magnetic poles of the magnetic ring of the driving magnet, respectively.

The arrangement of one of the driving magnet and the magnets of the stirring impeller including an integrated magnetic ring, can improve the rotational magnetic driving force on the stirring impeller while ensuring the magnetic attraction to the stirring impeller. Therefore, such small-sized magnetic ring can provide a larger stirring force, achieve stirring, improve the stirring effect, and be easy to assemble.

In a preferred embodiment, the driving magnet and the magnet in the stirring impeller may each include magnetic ring with the same structure. A magnetic ring with the same structure can include n sets of N and S magnetic poles, where n is greater than or equal to 1. That is to say, the driving magnet and the magnetic rings in the stirring impeller both include more than one pair of N and S magnetic poles, which can achieve better rotational magnetic driving effect.

In a preferred embodiment, n is 2, which means that there are two sets of N and S magnetic poles arranged in the magnetic ring, with the N and S magnetic poles spaced apart. This can further improve the stirring power of the stirring impeller while ensuring sufficient rotational magnetic driving force is provided, thereby improving the stirring effect.

The stirring impeller rotates by the driving magnet providing magnetic torque. In practice, when both the stirring impeller and the driving magnet use the same integrated magnetic ring, in the preferred embodiment, the outer contour size of the driving magnet is larger than that of the magnet in the stirring impeller to ensure sufficient rotational magnetic driving force of the driving magnet on the stirring impeller, thereby improving the stirring effect. In theory, if the outer contour size of the driving magnet is less than or equal to the outer contour size of the stirring impeller, but still can provide sufficient driving force to take the stirring impeller to rotate, the design can also be adopted where the outer contour size of the driving magnet is smaller than that of the stirring impeller.

In a preferred embodiment, the thickness of the driving magnet is greater than that of the magnet in the stirring impeller to ensure sufficient rotational magnetic driving force of the driving magnet on the stirring impeller, thereby improving the stirring effect.

In a preferred embodiment, the stirring impeller is detachably connected to a support shaft fixed at the bottom of the stirring container. For example, a central hole is provided in the stirring impeller, and a support shaft is provided at the bottom of the stirring container, so that the stirring impeller can be directly removed and placed. Through such detachable connection, the stirring impeller can be cleaned regularly and conveniently to prevent the deterioration of materials attached to the stirring impeller. When stirring different materials, the stirring container and stirring impeller can be cleaned in a timely manner to ensure the pure taste of the materials.

In a preferred embodiment, the outer surface of the magnet in the stirring impeller may be coated with a food grade material layer, with spaced convex blades formed on the material layer. The blades can be formed on the upper and/or lower surfaces and/or side surfaces of the stirring impeller. When the blades are formed on the upper or lower surface of the stirring impeller, each blade may extend outward from the center of rotation, and their radial lengths may be the same or different. The food grade material layer can prevent the magnets in the stirring impeller from corrosion by the materials, while also ensuring the taste and food safety of the materials. The convex blades can further improve the stirring effect on the materials.

Preferably, the outer surface of the magnet in the stirring impeller is coated with a layer of ferritic stainless steel or martensitic stainless steel. The layer is used to improve the durability of the stirring impeller without affecting the magnetic effect, while ensuring food safety.

Further preferred, the stirring impeller is provided with a hollow frame-shaped blade. Such a hollow frame design of the stirring blade allows liquid to flow through its hollow middle part, thereby preventing large fluctuations in the liquid level during the stirring process. In this case, the speed of the stirring impeller can be selected between 50~200 revolutions per minute to prevent foam from stirring due to fast speed or damaging fruit grains and other materials. When the stirring speed is selected, the motor can be replaced with a constant speed motor. These arrangements can achieve the best stirring effect.

In the preferred embodiment, the motor and the driving magnet can be sealed within the base housing. The base housing and stirring container are arranged separately. By sealing the motor and drive magnet inside the base housing, water and electricity isolation can be achieved, which improves the safety of the stirring device and also prevents the driving magnet from rusting and being contaminated by the materials. Moreover, by separating the base housing and the stirring container, the base housing can be easily moved to the most suitable position, and the stirring container can be replaced in a timely and convenient manner.

In the preferred embodiment, the installation regions for placing the stirring containers can be provided on the upper surface of the base housing, so that the stirring impeller inside the stirring container and the driving magnet can be arranged correspondingly and correctly. There can be snap parts on the installation area and the bottom outer side of the stirring container that cooperate with each other. The arrangement of the snap parts can further ensure that the driving magnet is arranged correspondingly to the stirring impeller, and can also increase the stability of the stirring container during the stirring process.

The application also provides a canister to be used in the aforementioned stirring device.

The application also provides a milk tea machine, comprising the above-mentioned canister. The canister is connected to the material conveying system of the milk tea machine to prepare milk tea with uniform stirring and consistent taste.

In a preferred embodiment, the milk tea machine further comprises a base housing containing a motor and a driving magnet driven by the motor in a sealed manner. The base housing and canister are arranged separately. By sealing the motor and driving magnet inside the base housing, water and electricity isolation can be achieved, improving operational safety and preventing rust and material contamination of the driving magnet. Moreover, by designing the base housing and the canister separately, the base housing can be easily moved to the most suitable position, and the canister can be conveniently replaced.

The present application will be further explained with reference to the accompanying drawings.

In the following explanation, the application is mainly described by using the stirring device installed on the milk tea machine as an example.

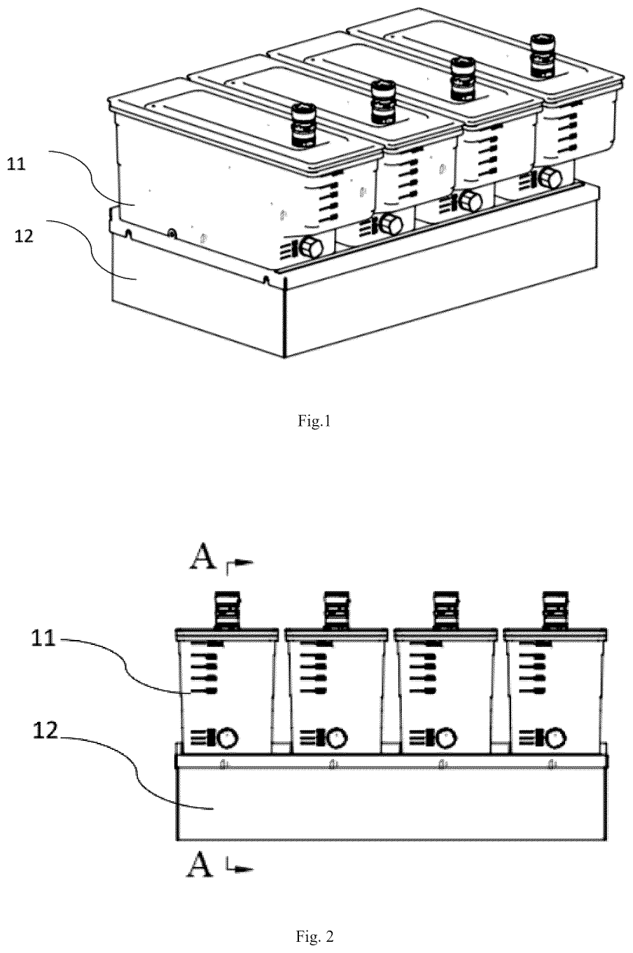

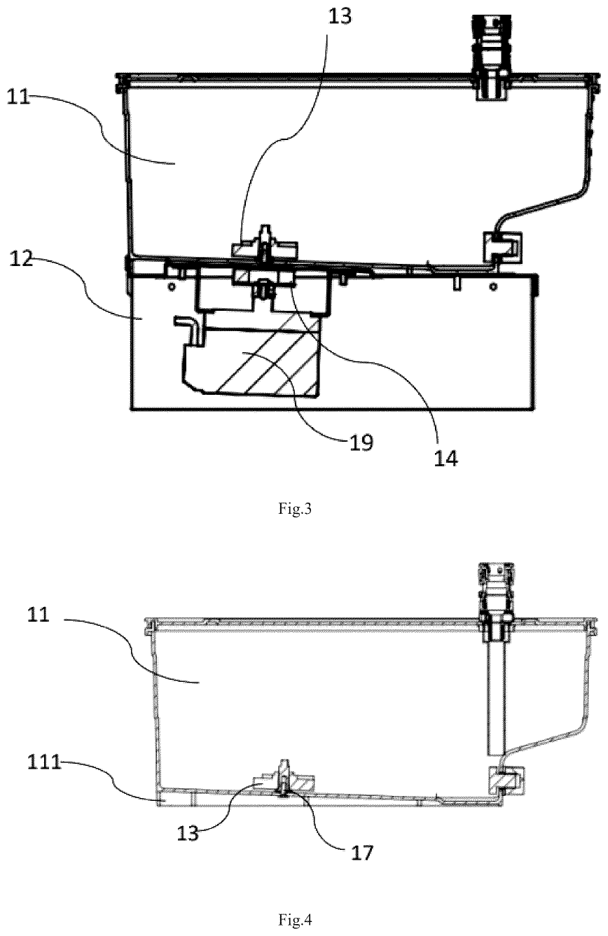

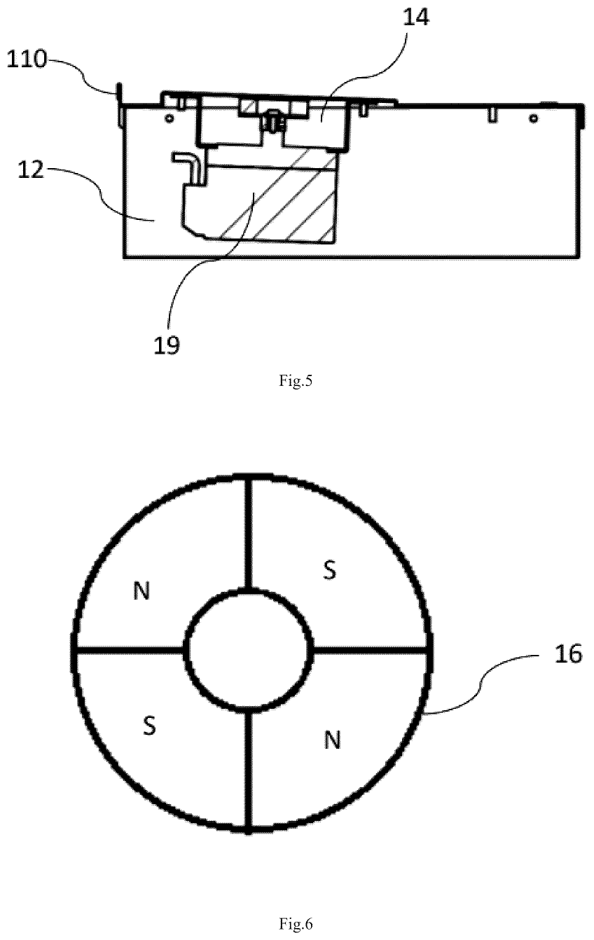

FIG. 1 illustrates symbolically a part of a stirring device according to an embodiment of the present application, where only a base housing and canisters placed on it are shown. FIG. 2 is the front view of FIG. 1. FIG. 3 shows a schematic cross-sectional view taken along line A-A in FIG. 2. FIG. 4 is a schematic diagram of the canister in FIG. 3. FIG. 5 is a schematic diagram of the base housing part in FIG. 3.

As shown in FIG. 1 and FIG. 2, multiple canisters 11 are placed on the base housing 12. As shown in FIGS. 3 and 4, a support shaft 17 is fixedly installed at the bottom of the canister 11. The stirring impeller 13 is rotatably connected to the support shaft 17. The connection method between the support shaft 17 and the bottom of the canister can be any known method, such as fixing with screws, bonding, or vacuum suction. Referring further to FIGS. 3 and 5, it can be seen that the driving magnet 14 driven by the motor 19 is correspondingly arranged below the stirring impeller 13. Referring to both FIG. 4 and FIG. 5, it can be seen that the canister 11 is provided with a second snap part 111, and the base housing 12 is provided with a first snap part 110. The base housing 12 and the canister 11 are assembled together through the first snap part 110 and the second snap part 111. The arrangement of the snap parts 111 and 110 can ensure that the driving magnet is set correspondingly to the stirring impeller, and can also improve the stability of the canister during the stirring process, so that the stirring impeller in the canister and driving magnet can be easily arranged correspondingly.

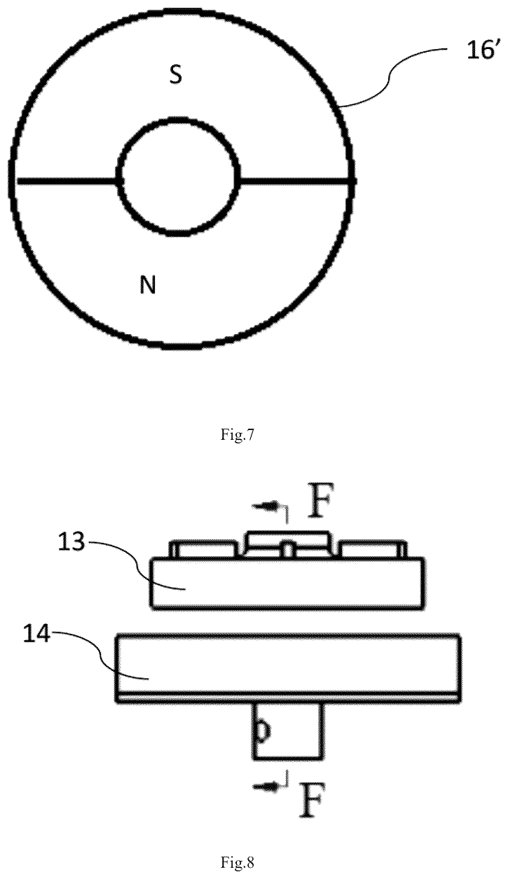

In this embodiment, the stirring impeller 13 includes an integrated magnetic ring 6 as shown in FIG. 6. The magnetic ring 16 includes two sets of N and S magnetic poles arranged at circumferential intervals. FIG. 7 shows an alternative example 16′ of magnetic ring 16. The magnetic ring 16′ in FIG. 7 includes an N magnetic pole and an S magnetic pole arranged in the circumferential direction. The structure of magnetic ring 16 is not limited by the example shown and can include n sets of N and S magnetic poles, where n is greater than or equal to 1.

The driving magnet 14 may include a corresponding magnet that cooperates with the magnetic ring 16 and can rotate the stirring impeller 13 through magnetic force. When starting motor 19, the driving magnet 14 can drive the magnetic ring 16 in the stirring impeller 13 to rotate, that is, drive the stirring impeller 13 to rotate, in order to stir the materials in the canister 11.

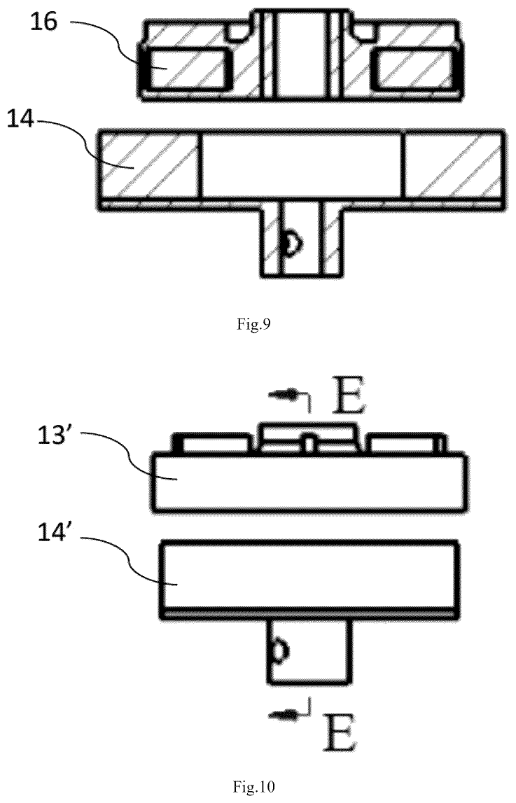

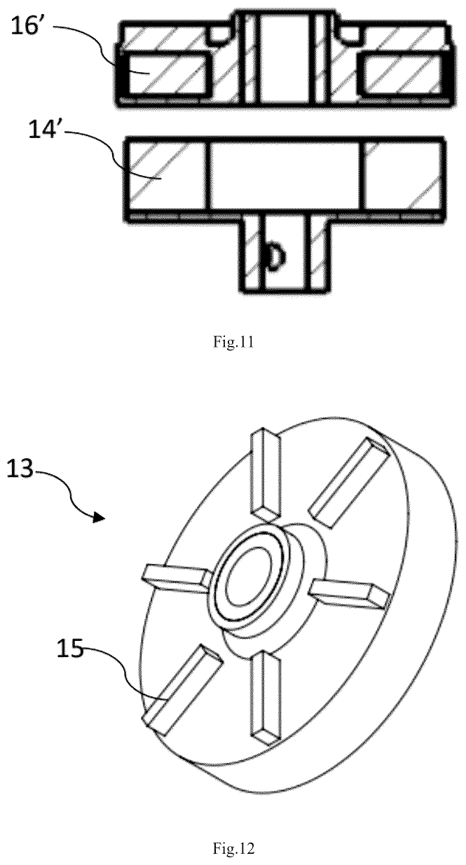

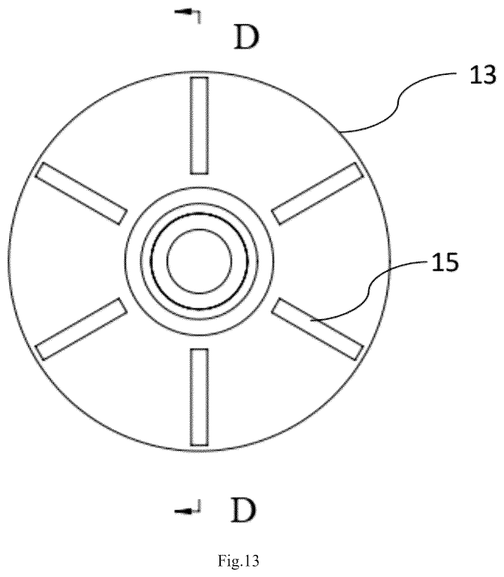

In this embodiment, the driving magnet 14 has the same structure as the magnetic ring 16 of the stirring impeller 13. And as shown in FIGS. 8 and 9, the outer contour size of the driving magnet 14 is larger than that of the magnet of the stirring impeller 13. In theory, the outer contour size of the magnet of the driving magnet 14 may be equal to that of the magnet of the stirring impeller 13, as shown in FIGS. 10 and 11. However, by adopting such structure, the driving magnet 14 and the stirring impeller 13 must be strictly coaxial, otherwise the stirring impeller 13 will be sucked by the driving magnet 14 and unable to rotate. In theory, the outer contour size of the magnet of the driving magnet 14 might be smaller than that of the magnet of the stirring impeller 13, as long as the driving magnet 14 can provide sufficient rotational driving force required by the stirring impeller 13. Optionally, the thickness of the driving magnet 14 may be greater than the thickness of the magnet of the stirring impeller 13. This further provides sufficient rotational magnetic driving force for the stirring impeller, thereby improving the stirring effect.

In this embodiment, the stirring impeller 13 is detachably connected to a support shaft fixed at the bottom of the stirring container. By detachable connection, the stirring impeller can be easily disassembled for cleaning on a regular basis to prevent the deterioration of materials attached to the stirring impeller. When stirring different materials, the stirring container and stirring impeller can be cleaned in a timely manner to ensure the pure taste of the materials.

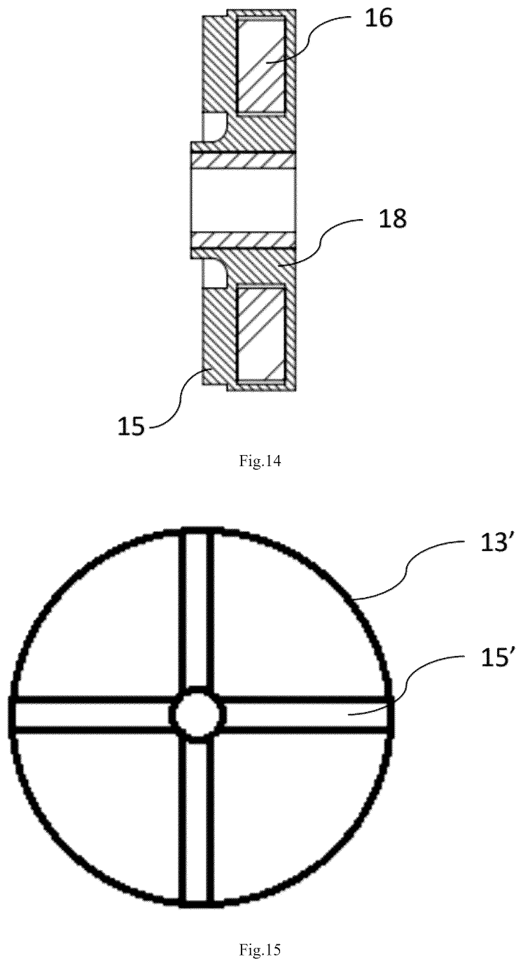

The outer surface of the stirring impeller 13 is coated with a layer of food grade material 18 and formed with spaced convex blades 15, as shown in FIGS. 12 to 14. The blades 15 consist of six spaced blades that extend radially and have the same length on the upper surface of the stirring impeller 16. The food grade material layer 18 can prevent the materials from corroding the magnet of the stirring impeller, and also ensure the taste of the materials. The convex blades 15 can further improving the stirring effect.

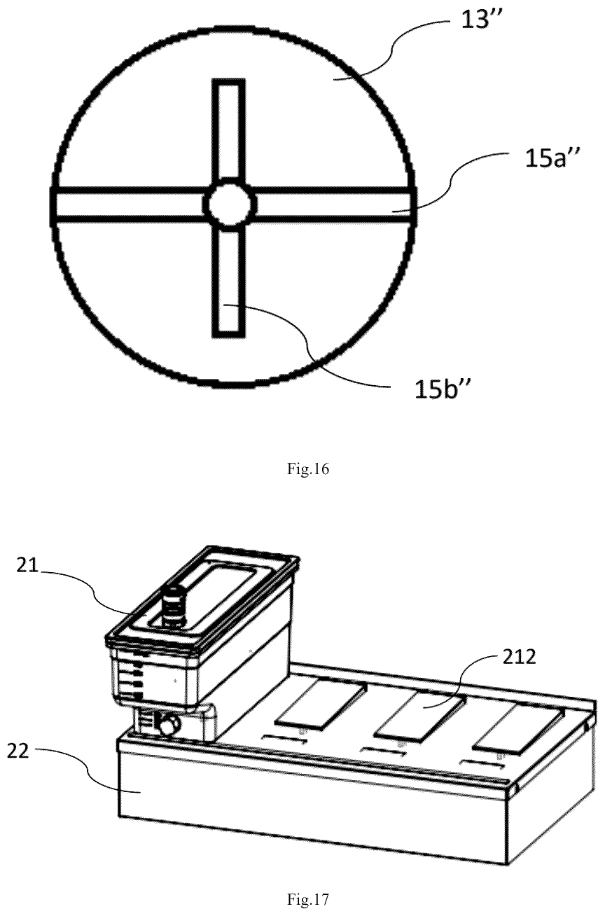

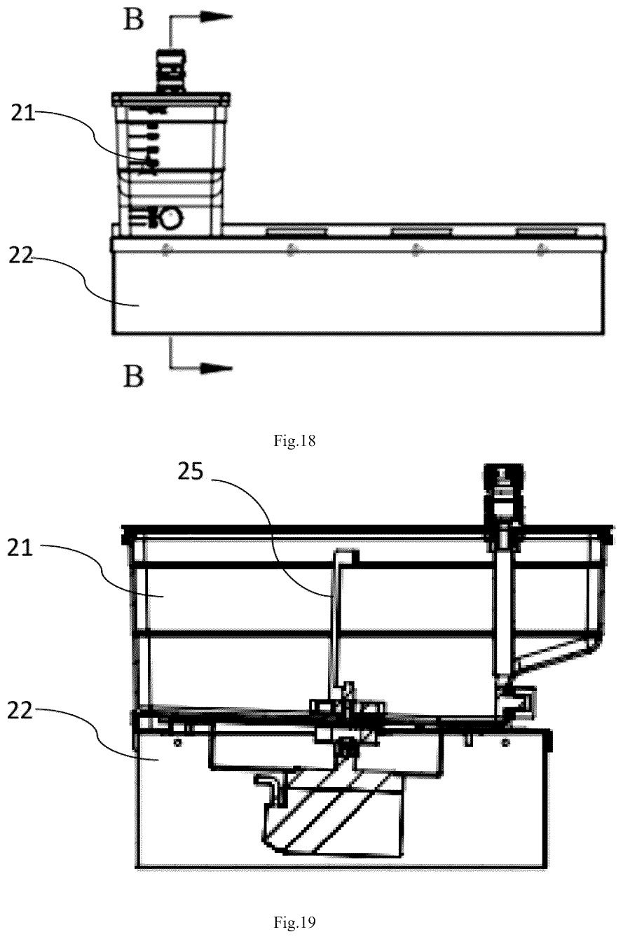

The stirring impellers 13′ and 13″ shown in FIGS. 15 and 16 are two alternative forms of the stirring impeller 13. The blades 15′ are four spaced blades that extend radially on the upper surface of the stirring impeller 13′ and have the same length. The blades 15″ are four spaced blades that extend radially on the upper surface of the stirring impeller 13″. The length of two blades 15a′ on one diameter is greater than the length of two blades 15b′ on the other diameter. Of course, other blade settings can also be used.

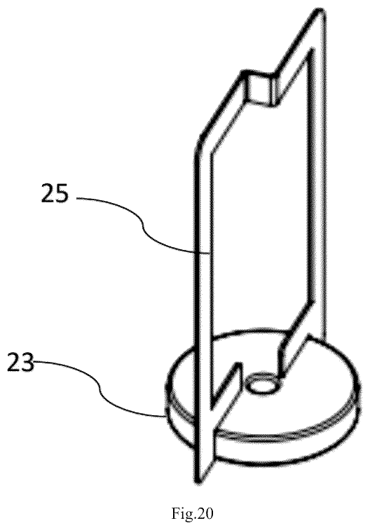

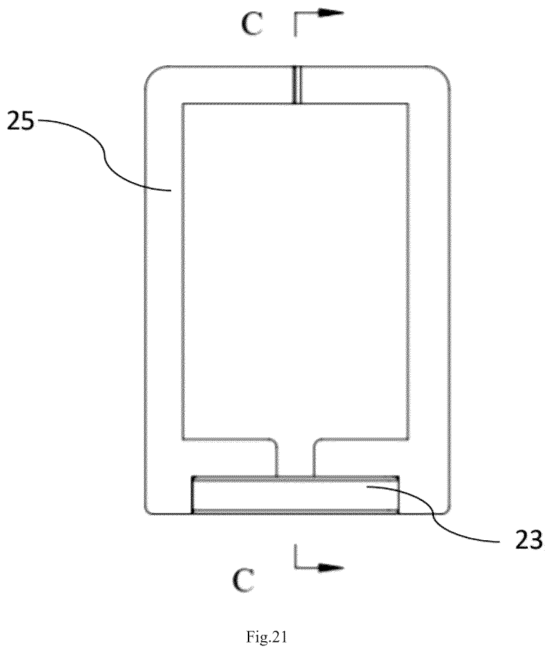

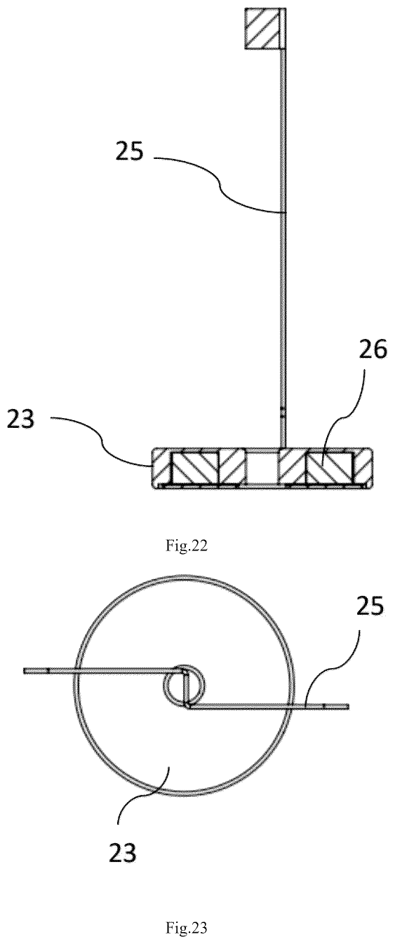

FIGS. 17 to 23 illustrate another embodiment of the stirring device according to the present application, with only one canister 21 placed on the base housing 22 as shown in FIG. 17. The difference from the previous embodiments is that, the outer surface of the magnet of the stirring impeller 23 in the canister 21 is coated with a layer of ferritic stainless steel or martensitic stainless steel, thereby improving the durability of the stirring impeller. Another difference from the previous embodiments is that the stirring impeller 23 is provided with a hollow frame-shaped blade 25, as shown in FIGS. 20 to 23. The height of the frame-shaped blade 25 can be close to the top of the canister (see FIG. 19). The hollow frame-shaped large blade design of the stirring blade can achieve good stirring effect and prevent large fluctuations in the liquid level during the stirring process. In this embodiment, the frame-shaped blade 25 is shown as a square frame, but the solution of the present application is not limited to this, and other shapes of frames such as circular, 8-shaped, or other irregular shapes can also be used.

Referring further to FIGS. 17 and 18, the installation regions 212 for the canisters (i.e. stirring container) are shown on the upper surface of the base housing 22. The other parts of this embodiment are the same as those of the previous embodiments and will not be repeated.

It should be noted that the stirring device defined by this application is not limited to be used in milk tea machines, and can be used in any other scenario where liquid needs to be stirred, especially suitable for stirring materials with different densities.

The above description only represents preferred embodiments of the present application and an illustration of the technical principles employed. It should be understood by those skilled in the art that the scope of the present application is not limited to the technical solution formed by a specific combination of the above technical features, but also encompasses other technical solutions formed by any combination of the technical features or their equivalent features, without departing from the concept of the present application mentioned above, for example, a technical solution formed by interchanging the above features with (but not limited to) technical features having similar functions disclosed in the present application.

1. A stirring device, comprising
a motor,
a driving magnet, operatively connected to the motor, and
a canister, comprising a stirring container and a stirring impeller rotatably provided at the bottom of the stirring container, with a magnet in the stirring impeller arranged correspondingly to the driving magnet;
wherein one of the driving magnet and the magnet in the stirring impeller includes an integrated magnetic ring, which includes one or more sets of N and S magnetic poles arranged in the circumferential direction, and the other of the two magnets includes a corresponding magnet that cooperates with the magnetic ring and can rotate the stirring impeller through magnetic force.

2. The stirring device according to claim 1, wherein the outer contour size of the driving magnet is greater than the outer contour size of the magnet in the stirring impeller.

3. The stirring device according to claim 1, wherein the thickness of the driving magnet is greater than the thickness of the magnet in the stirring impeller.

4. The stirring device according to claim 1, wherein the stirring impeller is detachably connected to a support shaft fixed at the bottom of the stirring container.

5. The stirring device according to claim 1, wherein the outer surface of the magnet in the stirring impeller is coated with a food grade material layer, and there are provided with spaced convex blades formed on the material layer.

6. The stirring device according to claim 1, wherein the outer surface of the magnet in the stirring impeller is coated with a food grade material layer, and there is provided with a frame-shaped blade formed on the material layer.

7. The stirring device according to claim 1, wherein the motor and the driving magnet are sealed and provided inside the base housing, which is separately provided fro the stirring container.

8. The stirring device according to claim 7, wherein one or more installation regions for placing the stirring container is/are provided on the upper surface of the base housing, so that the stirring impeller inside the stirring container is arranged correspondingly to the driving magnet.

9. The stirring device according to claim 1, wherein the driving magnet and the stirring impeller each include an magnetic ring with the same structure, and the magnetic rings with the same structure include n sets of N and S magnetic poles, where n is greater than or equal to 1.

10. The stirring device according to claim 9, wherein n is 2 and 2 sets of N and S magnetic poles are spaced apart.

11. The stirring device according to claim 2, wherein the driving magnet and the stirring impeller each include an magnetic ring with the same structure, and the magnetic rings with the same structure include n sets of N and S magnetic poles, where n is greater than or equal to 1.

12. The stirring device according to claim 11, wherein n is 2 and 2 sets of N and S magnetic poles are spaced apart.

13. The stirring device according to claim 3, wherein the driving magnet and the stirring impeller each include an magnetic ring with the same structure, and the magnetic rings with the same structure include n sets of N and S magnetic poles, where n is greater than or equal to 1.

14. The stirring device according to claim 13, wherein n is 2 and 2 sets of N and S magnetic poles are spaced apart.

15. A canister, wherein it is used for the stirring device according to claim 1.

16. A milk tea machine, wherein it includes the canister according to claim 15, which is connected to an material conveying system of the milk tea machine.
